(19) United States
(12) Patent Application Publication
(10) Pub. No.: US 2023/0186158 A1
(43) Pub. Date: Jun. 15, 2023

(54) METHOD FOR GENERATING TEACHING DATA IN ANALYSIS DATA MANAGEMENT SYSTEM

(71) Applicants: SHIMADZU CORPORATION, Kyoto-shi (JP); SUMITOMO RUBBER INDUSTRIES, LTD., Kobe-shi (JP)

(72) Inventors: Shiori NAGAI, Kyoto-shi (JP); Tomohiro KAWASE, Kyoto-shi (JP); Tomoya TSUDA, Kyoto-shi (JP); Satoshi YAMAMOTO, Kyoto-shi (JP); Hiroaki YAMADA, Kobe-shi (JP); Hiroyuki KISHIMOTO, Kobe-shi (JP); Wakana ITO, Kobe-shi (JP)

(21) Appl. No.: 17/926,450

(22) PCT Filed: Mar. 30, 2021
(86) PCT No.: PCT/JP2021/013665

§ 371 Date: Nov. 18, 2022

(30) Foreign Application Priority Data
May 21, 2020 (JP) 2020-088916

(51) Int. Cl. G06N 20/00

(52) U.S. Cl. CPC G06N 20/00

(57) ABSTRACT

For each of one or a plurality of types of samples, a database is constructed in which a sample identification tag and data belonging to at least two types of categories out of Categories (1), (2), and (3) are stored in association with each other. Data to be used as training data in supervised learning is selected from the database. At this time, one or a plurality of types of data is selected as an explanatory variable from one of the categories. Further, one or a plurality of types of data is selected as an objective variable from the other category. Then, training data is generated in which data corresponding to the selected explanatory variable is served as input and data corresponding to the selected objective variable is served as ground truth output. Category (1) is a plurality of types of samples relating to a production method of the sample, Category (2) is a plurality of types of samples acquired by analyzing a sample by one or a plurality of types of analyzers, and Category (3) is a plurality of types of physical property data that are information representing sample characteristics.

### TECHNICAL FIELD

The present invention relates to a method of generating training data for analyzing a plurality of samples and administering the analysis results for use in machine learning.

### BACKGROUND ART

An analyzer, such as, e.g., a gas chromatograph, a liquid chromatograph, a tensile testing machine, and a compression testing machine, is provided with dedicated data analysis software (analysis software). The analyzer analyzes the analysis results and/or the test results on analysis software to acquire features for use in statistical analyses and machine learning-related analyses.

For example, Patent Document 1 discloses a method of estimating a state of a structural complex. In this method, parameters acquired by a destructive inspection of a structural complex composed of a plurality of members and parameters acquired by a nondestructive measurement are associated with each other for statistical analyses. With this, a plurality of performances of the target structural complex is estimated, and therefore, the condition of the structural complex represented by the plurality of performances can be estimated.

### PRIOR ART DOCUMENT

### Patent Document

Patent Document 1: Japanese Unexamined Patent Application Publication No. 2018-036131

### SUMMARY OF THE INVENTION

### Problems to Be Solved by the Invention

There are various types of features acquired from a plurality of analyzers. Therefore, in order to utilize the features for AI analyses, statistical analyses, and the like, it is required to select and organize the features required for each sample out of the features generated by the respective analyzers, which requires labor and time.

For example, in the case of constructing a trained model, such as, e.g., an SVM (Support Vector Machine), for a plurality of types of features, it becomes crucial to appropriately select the types of features for generating a highly accurate and highly convergent model. However, it is required to extract data individually from the database for each analyzer and perform statistical analyses or the like, which requires a lot of labor and effort.

The present invention has been made to solve the above-described problems. The present invention aims to provide a method of generating training data in an analysis data management system capable of managing data acquired from a plurality of analyzers and reducing time and labor required for generating training data for use in machine learning.

### Means for Solving the Problems

In an explanatory method of generating training data in an analysis data management system according to the present invention, a database is initially constructed in which, for each of one or a plurality of types of samples, a sample identification tag and data belonging to at least two types of categories out of following categories (1), (2), and (3) are stored in association with each other.

Next, data to be used as training data in supervised learning is selected from the database. At this time, one or a plurality of types of data is selected as an explanatory variable from one of the categories. Further, one or a plurality of types of data is selected as an objective variable from the other category.

Then, training data in which data corresponding to the selected explanatory variable is served as input and data corresponding to the selected objective variable is served as ground truth output is generated.

Category (1): a plurality of types of data relating to a production method of the sample,
Category (2): a plurality of types of analysis data acquired by analyzing the sample with one or a plurality of types of analyzers, and
Category (3): a plurality of types of physical property data that is information representing characteristics of the sample

### Effects of the Invention

According to the present invention, analysis data of a plurality of samples by a plurality of analyzers is analyzed in a cross-sectional manner on single software, and data (data relating to the production method, analysis data, physical property data, and the like) for each sample can be collectively acquired and managed. Further, training data can be generated by selecting only data required for machine learning. Therefore, it is possible to greatly reduce the time and labor required for generating training data and a trained model.

### BRIEF DESCRIPTION OF THE DRAWINGS

FIG. 1 is a block diagram showing one example of a configuration of a training data generation system.

FIG. 2 is a flowchart showing a construction procedure of a database in the training data generation system.

FIG. 3A is a flowchart showing one example of construction processing of a learning model in the training data generation system.

FIG. 3B is a flowchart showing one example of construction processing of the learning model in the training data generation system.

FIG. 4A is a diagram showing a configuration example of a sample list Ls in a database to which information relating to a sample production method has been inputted.

FIG. 4B is a diagram showing a configuration example of the sample list Ls in the database to which physical property data has been inputted.

FIG. 4C is a diagram showing a configuration example of the sample list Ls in the database to which analysis data has been inputted.

FIG. 4D is a diagram showing a configuration example of the sample list Ls in the database to which features have been inputted.

FIG. 5 is a diagram showing a display example of a feature selection screen.

FIG. 6 is a diagram showing an example of a preview screen display of a training data table.

### EMBODIMENTS FOR CARRYING OUT THE INVENTION

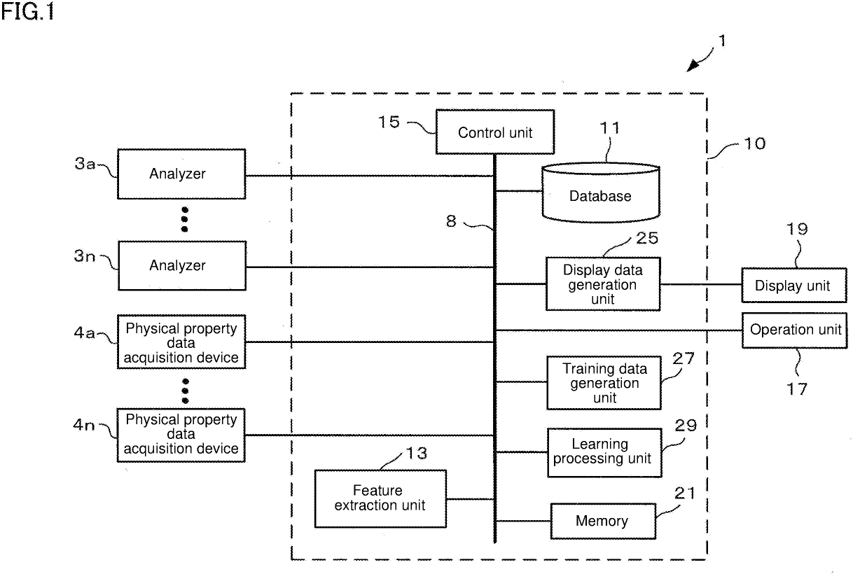

Hereinafter, some preferred embodiments of the present invention will be described in detail with reference to the attached drawings. FIG. 1 is a block diagram showing one example of a system configuration for generating training data according to an embodiment of the present invention.

A training data generation system 1 shown in FIG. 1 is provided with a data processing device 10. The data processing device 10 acquires features generated based on the analysis data acquired by a plurality of types of analyzers 3a ... 3n provided according to a analysis target (sample) by executing predetermined data processing and constructs a trained model by performing machine learning based on the features.

The control unit 15 of the data processing device 10 is composed of a CPU (Central Processing Unit) for controlling the operation of the entire device and executes predetermined data processing programs or the like stored in advance in a memory 21, such as, e.g., a ROM (Read Only Memory).

### Configuration for Storing Information in Database

To a database 11 of the data processing device 10, the user inputs information on a sample via a database operation software (front-end). The information on a sample denotes a tag (name, ID, Lot., etc.) for identifying a sample and information (blending quantity, blending process, etc.) on the production method of the sample.

In the database 11, the analysis data acquired by the analyzers 3a ... 3n is stored in association with the sample identification tag. The analysis data may be stored in the database 11 from the analyzers 3a ... 3n through measurement/analysis software (not shown) of the analyzers, or may be manually inputted by the user via database operation software.

In each analyzer 3a ... 3n, dedicated data analysis software (analysis software) performs an analysis of a sample based on the inputted analysis conditions to acquire analysis data.

As the analyzers 3a ... 3n, for example, a liquid chromatograph (LC), a gas chromatograph (GC), a gas chromatograph mass spectrometer (GC-MS), a liquid chromatograph mass spectrometer (LC-MS), a pyrolysis gas chromatograph mass spectrometer (Py—GC/MS), a liquid chromatograph photodiode array detector (LC-PDA), a liquid chromatograph tandem mass spectrometer (LC/MS/MS), a gas chromatograph tandem mass spectrometer (GC/MS/MS), a liquid chromatograph ion trap time-of-flight mass spectrometer (LC/MS-IT-TOF), a near-infrared spectrometer, a tensile tester, a compression testing machine, a transmission electron microscope (TEM), a scanning electron microscope (SEM), a nuclear magnetic resonator (NMR), an emission spectroscopic analyzer (AES), an atomic absorption analyzer (AAS/FL-AAS), a plasma emission spectrometer (ICP-AES), a plasma mass spectrometer (ICP-MS), a fluorescent X-ray analyzer (XRF), an organic element analyzer, a glow discharge mass analyzer (GDMS), a particle composition analyzer, a trace total nitrogen automatic analyzer (TN), a high-sensitivity nitrogen carbon analyzer (NC), a Fourier transform infrared spectrophotometer (FT-IR), a thermal analyzer, etc., are available.

In the database 11, the physical property data of the sample is stored in association with the sample identification tag. The physical property data may be stored in the database 11 directly from physical property data acquisition devices 4a ... 4n by the control unit 15, or may be inputted by the user via database operation software.

In a case where the sample is a tire, the physical property data is exemplified by a composition (abundance ratio, specific gravity, expansion coefficient), a particle diameter of a filler, a mean inter-particle distance of the fillers, dielectric loss tangent, abrasion resistance, tensile strength (TB), breaking elongation (EB), tensile stress (Mn), spring hardness (HS), loss factor (tan δ), and the like. In the present invention, the physical property data is not particularly limited thereto and may be any data used in evaluating a sample. Here, the loss factor is the ratio between the loss modulus, which indicates a rough indication of energy dissipation, and the elastic modulus component in which energy is stored as it is in the system.

As described above, in a case where the sample is a tire, the physical property data acquisition devices 4a ... 4n may be a tensile testing machine, a compression testing machine, a viscoelastic tester, a wear tester, and the like.

The data processing device 10 includes a feature extraction unit 13 that generates features based on the analysis data stored in the database 11.

As the features, the examples thereof include, for example, analysis data, such as, e.g., an electron microscope image acquired by an SEM or an TEM, a chromatograph acquired by a GCMS or an LCMS, an MS spectrum, and a spectrum acquired by an FT-IR or an NMR, or composition, a concentration, molecular structure, number of molecules, molecular formula, molecular weight, degree of polymerization, particle diameter, particle area, particle number, particle dispersion degree, peak intensity, peak area, peak slope, concentration of compound, compound amount, absorbance, reflectance, transmittance, sample test strength, Young’s modulus, tensile strength, deformation amount, strain amount, fracture time, mean inter-particle distance, dielectric loss tangent, elongation, spring hardness, loss factor, glass transition temperature, and coefficient of thermal expansion of a sample, which are calculated from the analysis data or the test data.

The features generated by the feature extraction unit 13 are stored in the database 11 in association with the sample identification tag.

As described above, in the database 11, for each sample, the information relating to the production method, the analysis data acquired by the plurality of different analyzers 3a ... 3n, the data of the plurality of types of features extracted from the analysis data, and the plurality of types of physical property data are stored in association with each other.

### Configuration for Generating Training Data

In response to the information inputted by the user operating the operation unit 17, the display data generation unit 25 selects data, such as, e.g., features associated with the sample identification tag, from the database 11 and generates display data in a predetermined display format displayable on a display unit 19.

The training data generation unit 27 generates training data from the data stored in the database 11 in response to the information inputted by the user operating the operation unit 17.

For example, training data is generated in which the data of the “analysis data or features” is served as input and the data of the “physical properties” associated with the sample identification tag in the same manner as in the features is served as output. Similarly, training data may be generated in which the data of the “information (e.g., blending ratio)″ relating to the production method of the sample” is served as input, and the data of the “physical property” or the “analysis data or features” is served as output. Further, it may be configured such that the data of the “physical property” is served as input, and the data of the “analysis data or the features” or the “information relating to the production method of the sample” is served as output. Further, it may be configured such that the data of the “analysis data or features” is served as input, and the data of the “information relating to the production method of the sample” is served as output.

The generated training data is inputted to a learning processing unit 29. The training data may be stored in the database 11 each time it is generated. With this, training data is accumulated in the database 11.

Before storing the training data in the database 11, the training data generation unit 27 displays a confirmation screen for confirming whether to store the training data in the database on the display unit 19. The training data generation unit 27 stores the training data in the database 11 based on the fact that an instruction to store the training data is performed by the user on the confirmation screen. In a case where there is no such an instruction, the training data generation unit 27 discards the training data.

With this, the learning processing unit 29 can collectively use the plurality of features for AI (artificial intelligence) analyses, statistical analyses, and the like.

The machine learning method in the learning processing unit 29 is not particularly limited, and known machine learning, such as, e.g., a neural network (Neural Network: NN) and a support vector machine (SVM), can be used.

### Other Configurations

The operation unit 17 is composed of, for example, a keyboard, a mouse, a touch panel, and the like, and the user uses the operation unit 17 to perform various operations, such as, e.g., an input of information relating to the sample, a display of data, and a selection of the data to be used to generate training data. The display unit 19 is a monitor configured by, for example, a liquid crystal display.

The control unit 15, the database 11, the feature extraction unit 13, the display data generation unit 25, the training data generation unit 27, the learning processing unit 29, etc., described above, are connected to each other via a data bus 8.

In place of the operation unit 17 and the display unit 19, for example, an information terminal, such as, e.g., a desktop-type personal computer (PC), a notebook-type PC, or a portable terminal (a tablet terminal or a smartphone), may be connected to the control unit 15.

Next, the construction procedure of the database, the output processing procedure of features, the construction procedure of the learning model, etc., in the training data generation system according to this embodiment will be described with reference to a tire as a concrete sample of an analysis target.

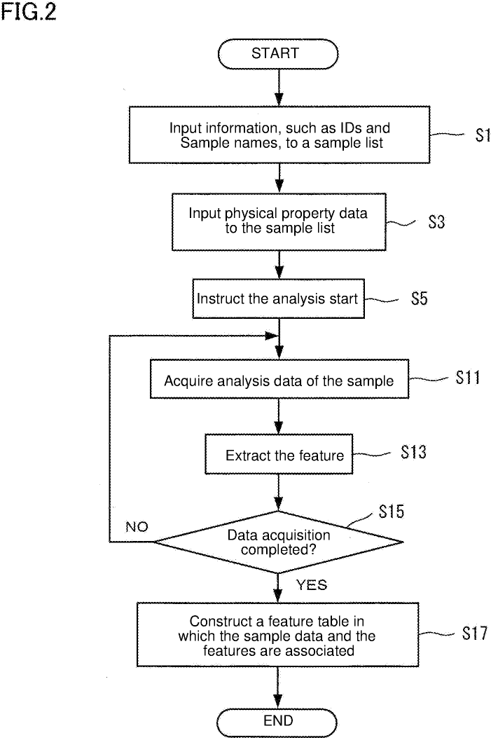

First, with reference to the flowchart shown in FIG. 2, the construction procedure of the database in the training data generation system according to this embodiment will be described.

In Step S1 of FIG. 2, the user inputs the sample name “Tire C” of the tire C, which is a measurement target sample, and the information (the sulfur content “0.221,” the silica content “0.589,” and the stirring time “10”) relating to the production method of the tire C to a sample list Ls of the database 11 via database operation software (front-end) (not shown).

In response to the information input relating to a new sample by the user, the control unit 15 assigns a sample ID “A03” that is a sample identification tag.

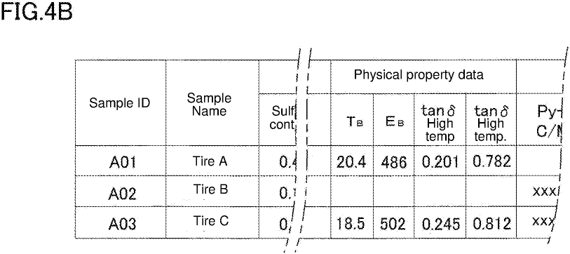

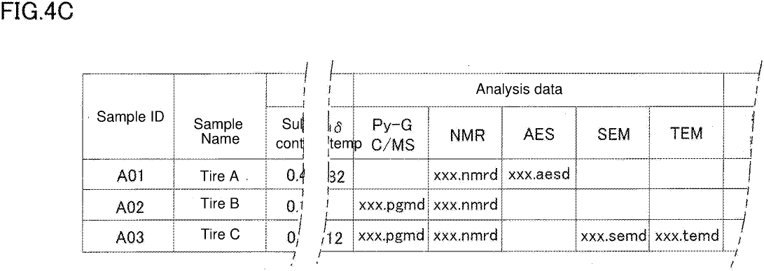

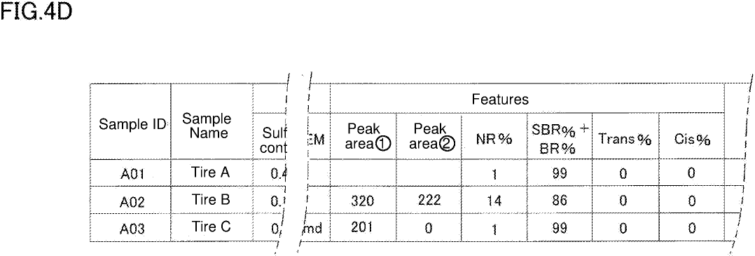

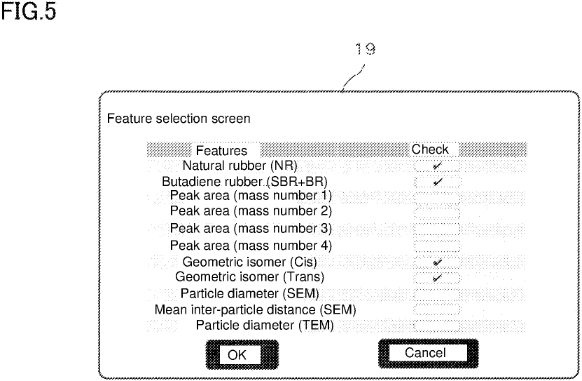

The sample list denotes a data set group generated according to the type of the project or the sample, and the configuration thereof is not particularly limited. The sample list Ls in the database 11 to which the information relating to the production method of the sample has been inputted by the user as described above is configured, for example, as shown in FIG. 4A. Note that, FIG. 4A shows an example in which the information on the sample IDs “A01” and “A02” has been already registered.

In Step S3 of FIG. 2, the user inputs the physical property data of the tire C in association with the sample ID “A03” to the database 11 via database operation software (front-end) (not shown). Here, based on the data measured by a testing machine, the tensile strength (TB) “18.5” and the breaking elongation (EB) “502” are inputted. Further, the loss factor (tan δ at high temperature) “0.245” at a high-temperature state and the loss factor (tan δ at low temperature) “0.812” at a low-temperature state, which were acquired by calculation, are inputted.

The sample list Ls in the database 11 to which these physical property data has been inputted is configured as shown in FIG. 4B. Note that the input timing of the physical property data is not limited to the timing of Step S3 and may be inputted at other timings.

Note that an example has been described in which the user inputted the physical property data via database operation software, but the present invention is not limited thereto. The physical property data may be stored in the database 11 by the control unit 15 directly from the physical property data acquisition device 4a ... 4n.

In Step S5 of FIG. 2, for the tire C, analyses by analysis software are performed using four types of analyzers, i.e., a pyrolysis gas chromatograph mass spectrometry (Py-GC/MS), a nuclear magnetic resonator (NMR), a scanning electron microscopy (SEM), and a transmission electron microscopy (TEM), to acquire analysis data. For that, the user sets a segment of the tire C, which is a measurement target sample, on the Py-GC/MS, the NMR, the SEM, and the TEM and starts the analyses of the segment. The condition setting and operation relating to the analyses may be performed via measurement/analysis software (not shown) of the analyzer 3a ... 3n, or may be performed via the control unit 15.

In Step S11, the analysis software instructed to start the analysis of each of the tires C performs analyses based on the inputted analysis conditions with the Py-GC/MS, the NMR, the SEM, and the TEM. In the Py-GC/MS, after the tire segment has been decomposed into fine particles by a pyrolyzer, they are separated by a column provided in a gas chromatograph (GC), and the separated components are detected by a mass analyzer (MS) to acquire the mass spectrum or the waveform data of the total ion chromatogram (TIC). In the NMR, an NMR spectrum is acquired by irradiating the sample with a radio wave having the same frequency as the resonance frequency.

An SEM generates an electron beam by an electron source, focuses the electron beam accelerated by an electron gun as an electron spot on a sample by a focusing lens and an objective lens, moves the electron spot as a prove on the sample by a scanning coil to perform electron beam scanning, detects the signal electrons generated from an electron beam irradiation point of the sample by a detector, and displays the quantity of signal electrons as the brightness of each point, thereby acquiring an SEM image.

Further, the SEM can acquire an energy spectrum of X-rays by injecting an electron beam and detecting X-rays emitted from a sample.

The TEM irradiates a sample with an electron beam, detects the transmitted electron beam, and acquires the spatial distribution (TEM image) of the electron transmittance in the sample based on the intensity of the electron beam.

Here, the total ion chromatogram acquired by the Py-GC/MS, the NMR spectrum acquired by the NMR, and the energy spectrum acquired by the SEM may be normalized such that the component having the highest intensity in each waveform data is used as the base peak and the relative intensity is 100%.

The analytical data file acquired by each analyzer is stored in the database 11 in association with the sample ID. The sample list Ls in the database 11 to which the analysis data has been inputted is configured as shown in FIG. 4C.

Although an example has been described in which measurements are performed, the present invention is not limited thereto. In Step S11, already measured data may be taken from the database 11 or the analyzer.

In Step S13, the feature extraction unit 13 extracts features by reading out the analysis data from the database 11 and stores the features in the database 11.

For example, for the tire C, the total ion chromatogram acquired by the Py-GC/MS is analyzed, and the area value of the peak with respect to a predetermined mass number which is the feature is calculated. Further, the NMR spectrum acquired by the NMR is analyzed to calculate the abundance ratio of natural rubber (NR), butadiene rubber (SBR + BR), and geometric isomers (Cis, Trans) of these rubbers, which are features.

Although the feature extraction unit 13 is included in the data processing device 10 in the embodiment shown in FIG. 1, the present invention is not limited thereto. The feature extraction unit may be included in each analyzer 3a ... 3n. In such a case, for example, the measurement/analysis software (not shown) of the analyzer 3a ... 3n functions as a feature extraction unit.

Further, in Step S13, the SEM image acquired from the SEM is analyzed to calculate the particle diameter and the mean inter-particle diameter of the filler particle present in the tire, which are features. Further, the TEM image acquired by the TEM is analyzed to calculate the particle diameter of the filler particle present in the tire.

Here, the abundance ratio of each rubber contained in the tire is calculated based on the waveform data of the NMR spectrum acquired by analyzing each tire to be measured by the NMR and the calibration curve data stored in a storage unit (not shown).

The calibration curve data is a relational expression representing the relation between the quantitative value calculated from the NMR spectrum acquired by analyzing a sample containing a target component of a known concentration by an NMR and the abundance ratio.

In this embodiment, a sample containing natural rubber (NR), butadiene rubber (SBR + BR), and geometric isomers (Cis, Trans) of these rubbers, whose abundance ratio is known, is prepared before starting the analysis. A quantitative value (the area value or the intensity value of the peak) calculated from the spectrum acquired by analyzing these samples by the NMR is calculated, and the calibration curve data indicating the relation between the abundance ratio and the quantitative value of each rubber is generated and stored in a storage unit (not shown).

The sample list Ls in the database 11 to which such features have been inputted is configured as shown in, for example, FIG. 4D.

In Step S15, it is determined whether or not the total ion chromatogram, the NMR spectrum, the SEM image, and the TEM image described above have been acquired and whether or not the calculation of the abundance ratio of each rubber, the area value of the peak with respect to each mass number, the particle diameter acquired from the SEM image, the mean inter-particle distance, and the particle diameter acquired from the TEM image has been completed.

In the above-described embodiment, an example has been described in which data is stored for one sample (tire C), but the present invention is not limited thereto. Analysis data and/or physical property data may be acquired for a plurality of samples.

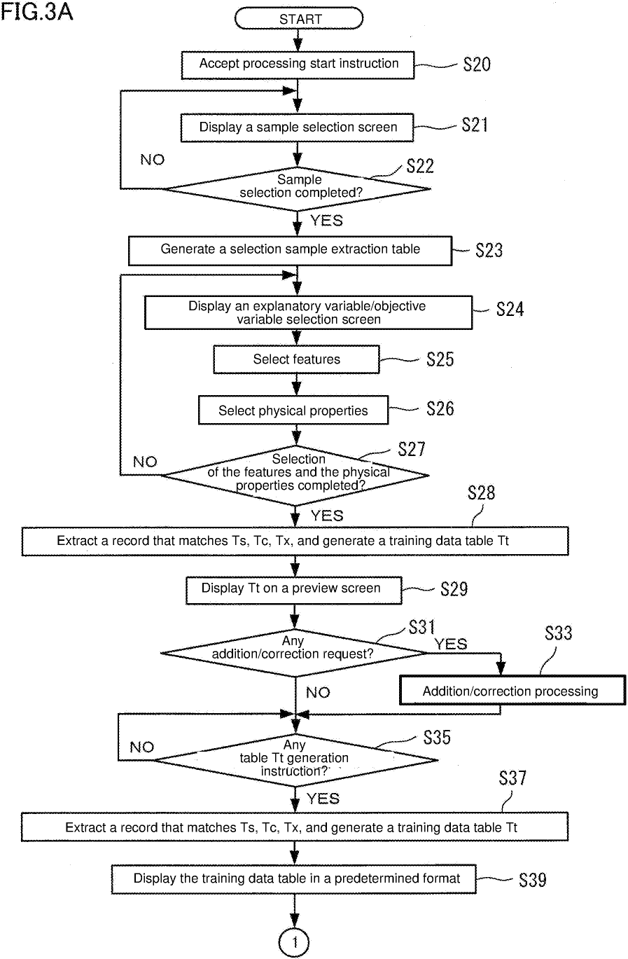

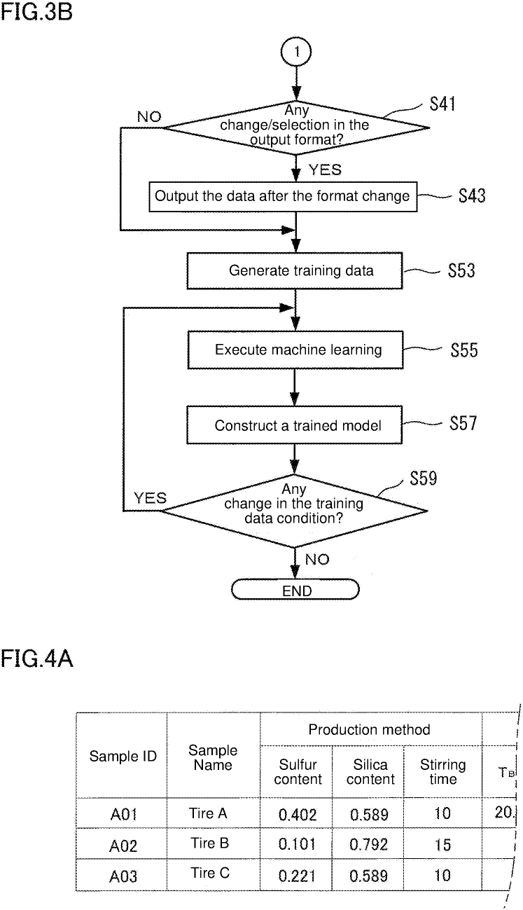

FIG. 3A and FIG. 3B are a flowchart showing one example of the generation of the training data table Tt and the construction processing of the learning model in the training data generation system according to this embodiment.

In the display unit 19 of the training data generation system 1 shown in FIG. 1, a user interface (UI) screen for generating the training data table Tt, the processing results, etc., are displayed. In the case of giving an instruction to start generation of the training data table Tt, the user of the training data generation system 1 operates the operation unit 17 in Step S20 of FIG. 3A to select (click) a desired start instruction icon of the training data generation application displayed on the UI screen of the display unit 19.

Upon receiving the start instruction, the control unit 15 displays a sample selection screen in Step S21 of FIG. 3A. The sample selection screen is a screen for the user to select a sample to be used for generating training data.

The sample selection screen may be configured by a list composed of a sample name and information relating to the production method of the sample, for all of the samples stored in the database 11.

Alternatively, the names of the plurality of sample lists stored in the database 11 may be displayed on the sample selection screen. In this case, it may be configured such that when one sample list (e.g., Ls) is selected, all of the samples (tire A, tire B, tire C) included in the sample list is selected.

In addition, in the sample selection screen, for example, a selection icon corresponding to an individual sample or a sample list is displayed. The user can select any sample by checking the selection icon via the operation unit 17.

In Step S22, the control unit 15 determines whether or not the selection of a sample by the user has been completed. Upon completion of the sample selection, the control unit 15 extracts the selected row in Step S23 to generate a selection sample extraction table Ts. The selection sample extraction table Ts may be configured to be displayed on the display unit 19 to confirm the selection result.

For example, a case where the user has selected a sample list Ls (that is, the tire A to the tire C) will be described. In this case, the sample IDs “A01,” “A02,” and “A03” are stored in the selection sample extraction table Ts.

Upon completion of the above-described sample selection, the control unit 15 displays an explanatory variable selection screen and an objective variable selection screen in Step S24. The explanatory variable selection screen and the objective variable selection screen are screens each for selecting the type of data that the user uses for inputting and outputting training data.

Note that the training data generation application may be prepared for each set of a category used as an explanatory variable of supervised learning and a category used as an objective variable. In this case, only the operation to select a training data generation application can complete the selection of the type of data to be used for inputting and outputting the training data.

Here, an example will be described in which an application for generating training data is selected in which feature data (Category (2) recited in claims) “abundance ratio of natural rubber (NR),” “abundance ratio of butadiene rubber (SBR + BR),” “abundance ratio of geometric isomer (Cis),” and “abundance ratio of geometric isomer (Trans)” are served as input, and physical property data (Category (3) recited in claims) in which the “tensile strength (TB)” is served as output.

First, in the explanatory variable selection screen (see FIG. 5), the user operates the operation unit 17 to select the data types of a plurality of features from the feature list displayed on the display unit 19 (Step S25). In the explanatory variable selection screen, the feature list Lc is displayed in the left-hand column. The feature list Lc is generated from the data narrowed down to the samples in the selection sample extraction table Ts out of all of the data stored in the database 11, excluding the duplication of feature types.

Further, on the explanatory variable selection screen, selection icons corresponding to the types of features are displayed. The user can select any features in the feature list Lc by checking the selection icons via the operation unit 17.

In this embodiment, as shown in FIG. 5, the feature list Lc includes, as the types of features, the area value of the peak with respect to a particular mass number, the abundance ratio of natural rubber (NR), butadiene rubber (SBR + BR), and geometric isomers (Cis, Trans) of these rubbers, the particle diameter and the mean inter-particle distance of the fillers acquired from an SEM image, and the particle diameter of the filler acquired from a TEM image. The types of these features are displayed on the feature selection screen.

In the example shown in FIG. 5, the user has selected, in the feature selection screen of the operation unit 17, the “abundance ratio of natural rubber (NR),” the “abundance ratio of butadiene rubber (SBR + BR),” the “abundance ratio of geometric isomer (Cis),” and the “abundance ratio of geometric isomer (Trans),” which are the types of features. Therefore, check marks (✓) are entered in the check boxes. In this way, the data types of the selected features are stored in the selection explanatory variable table Tc.

In the subsequent Step S26, the user selects one or a plurality of objective variables (physical characteristics) from an objective variable selection screen (not shown). In the objective variable selection screen, for example, abrasion resistance, tensile strength (TB), breaking elongation (EB), tensile stress (Mn), spring hardness (HS), loss factor (tan δ), and the like, are displayed as physical property data.

Here, the selection icons corresponding to the types of the physical properties (physical property list) are displayed on the objective variable selection screen. Therefore, the user can select any physical properties by checking selection icons via the operation unit 17. In this way, the selected physical property data types are stored in the selection objective variable table Tx.

The control unit 15 determines, in Step S27, whether or not the selection of the explanatory variables (data types of features) and the objective variables (the data types of the physical properties) by the user have been completed. Upon completion of the selection, the control unit 15 extracts the records that match the selection sample extraction table Ts, the selection explanatory variable table Tc, and the selection objective variable table Tx from the database 11 in Step S28 to generate a training data table Tt. Then, the training data table Tt is displayed on the preview screen in Step S29.

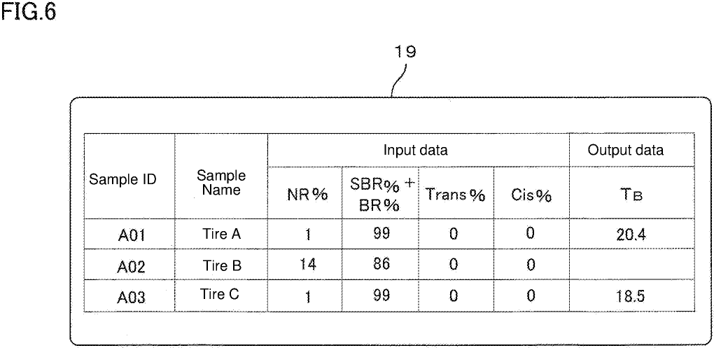

As shown in FIG. 6, in the preview screen, the sample names (Tire A to Tire C) selected in the above-described Steps S21 and S23 are displayed on the display unit 19 in the vertical direction (in the column direction), and the explanatory variables (data types of features) and the objective variables (data types of physical properties) selected in the above-described Steps S24 to S27 are displayed on the upper part of the screen in the horizontal direction (in the row direction).

The control unit 15 determines whether or not there is an addition/modification request by the user in Step S31 such that the user who viewed the preview screen can add and modify the sample or the data type.

For example, in the example shown in FIG. 6, it can be seen that information on the tensile strength (TB) of the tire B has not been stored in the database 11. Therefore, it is conceivable that the user inputs the data of the tensile strength (TB) of the tire B or makes a correction such as excluding the tire B from the selection sample table.

In a case where there is an addition/modification request as described above, addition/modification processing is executed in Step S33. The control unit 15 performs information addition/deletion to the selection sample extraction table Ts, the selection explanatory variable table Tc, and the selection objective variable table Tx according to the modification contents. In this way, the user can select data to be used for machine learning described later.

The control unit 15 waits for a generation instruction of a training data table Tt from the user in Step S35. For example, when a table generation instruction icon displayed on the UI screen is selected (clicked) via the operation unit 17, the processing proceeds to the processing of Step S37.

In Step S37, a record that matches the selection sample extraction table Ts, the selection explanatory variable table Tc, and the selection objective variable table Tx is extracted from the database 11 again to generate a training data table Tt. Then, in Step S39, the display data generation unit 25 displays the training data table Tt on the display unit 19 in a table display format.

The control unit 15 determines in Step S41 of FIG. 3B whether or not the user has selected to change the output format of the display data described above. Changing the output format means changing the features of each sample displayed in Step S39 to a format that can be displayed by, for example, a CSV (Comma-Separated Values) format or a format that can be displayed by AI software or related software, such as, e.g., statistical analysis software.

Specifically, in a case where the user has selected (clicked) the output format change instruction icon displayed on the UI screen by the operation unit 17, the control unit 15 stores the data whose output format has been changed in the database 11 in Step S43 or outputs it to an external device and external software via an interface (not shown), such as, e.g., a LAN and a WAN.

Note that in this embodiment, the training data table Tt is generated by selecting the abundance ratio of natural rubber (NR), butadiene rubber (SBR + BR), and geometric isomers (Cis, Trans) of these rubbers, which are the features generated from the NMR spectrum acquired from the NMR. However, the NMR spectrum, the total ion chromatograph, the SEM image acquired from the SEM, the TEM image acquired by the TEM, which are analysis data, may be displayed as selection targets on the feature selection screen.

Next, in Step S53 of FIG. 3B, the training data generation unit 27 generates training data based on the training data table Tt generated by the display data generation unit 25. The training data generation unit 27 generates training data in which the abundance ratio of natural rubber (NR), butadiene rubber (SBR + BR), and geometric isomers (Cis, Trans) of these rubbers, selected by the user as explanatory variables are served as input, and the tensile strength (TB) selected by the user as an objective variable is served as output.

In Step S55, the learning processing unit 29 applies the training data generated in Step 53 to a learning model to execute machine learning or statistical analyses. In the following, a support vector machine (SVM) will be described as an exemplary training method.

In the following Step S57, the learning processing unit 29 inputs the abundance ratio of natural rubber (NR), butadiene rubber (SBR + BR), and geometric isomers (Cis, Trans) of these rubbers, which are features, to a SVM to compare the tensile strength (TB) of the tire acquired from the SVM and the tensile strength (TB) as training data contained in the training data.

Then, the learning processing unit 29 updates various parameters in the current SVM so that the tensile strength (TB) outputted from the SVM approaches the tensile strength (TB) as training data and generates a trained model.

Note that even in a case where the user has selected breaking elongation (EB), tensile stress (Mn), spring hardness (HS), loss factor at high temperature (tan δ at high temperature), loss factor at low temperature (tan δ at low temperature), and the like, as the output data, the learning processing unit 29 performs the same processing as in the above-described tensile strength (TB) to generate a trained model for each of them.

In Step S59, it is determined whether or not there is a change in the training data condition. If there are any changes, the processing of Steps S55 and S57 is repeated. By repeating the machine learning in this manner, the accuracy of the training is improved.

The database 11 includes the identification information for identifying the learning model, the generation date and time information on the learning model, the identification information for identifying the training data which is a generation source of the learning model, the identification target information (not shown) defining an identification target by the learning model, or the like.

Note that it may be configured such that the above-described selection of the types of features is automatically performed by a computer and that the automatic selection is dynamically changed based on the degree of convergence of training in the trained model generation step.

As described above, by the training data generation system (analysis data management system) according to this embodiment, it is possible to collectively acquire and manage the features for each sample by transversally analyzing the analysis data of a plurality of samples by a plurality of analyzers on single software. At the same time, since the machine learning can be performed by selecting only the training data required for machine learning, the time and labor required for the machine learning can be greatly reduced, and therefore, the time and labor required to generate a plurality of learners can be greatly reduced by changing the conditions of the training data.

Further, in the training data generation system, the features corresponding to a plurality of types of features can be combined for each sample on single software, which can greatly reduce the labor and time required for the machine learning and statistical analyses in which the features are served as training data.

### Modifications

In the training data generation system according to this embodiment, it is configured such that the analysis data is stored in the database 11 from the analyzers through a measurement/analysis software (not shown) of the analyzers 3a ... 3n, but the present invention is not limited thereto. For example, the analysis data may be stored in the database 11 directly from the analyzers by the control unit 15 without using measurement/analysis software (not shown).

In the training data generation system according to this embodiment, it is configured such that the features are generated by the feature extraction unit 13 in the data processing device 10 based on the analysis data stored in the database 11, but the present invention is not limited thereto. For example, the user may input the features to the data processing device 10. Alternatively, the features generated by another software (such as, e.g., measurement/analysis software of the analyzers 3a ... 3n) may be inputted to the data processing device 10.

In the training data generation system according to the above-described embodiment, it is configured such that the user can select samples and the types of the features via the UI screen, but the present invention is not limited thereto. For example, it may be configured such that in addition to the types of samples and features, a plurality of types of data analysis-related analyzers is selectable.

Further, in the processing shown in FIG. 3A, it is configured such that the user selects the data types of the sample, the explanatory variables, and the objective variables, but the present invention is not limited thereto. For example, it may be configured such that the user selects the type of the features on the feature selection screen on which the feature list Lc composed of all data contained in the database 11 is displayed to store them in the feature extraction table, and a record that matches the selection sample extraction table Ts, the selection explanatory variable table Tc, and the selection objective variable table Tx is extracted from the feature extraction table to generate a training data table Tt together with the corresponding sample.

Further, it is also useful to generate a combination set of types of desired data in advance. In the processing shown in FIG. 3A, after the sample selection is completed in Steps S21 to 23, a screen for selecting the set is displayed. Then, the type of data to be used for inputting and outputting the training data is selected from the types of data included in the desired set. With this configuration, training data can be easily generated even in a case where there are a large number of types of data.

Further, for example, it may be configured such that only a sample is selected by the user, and the selected sample and all corresponding data are displayed in a tabular format.

On the other hand, in the above-described embodiment, the sample ID and the data associated therewith are displayed in a two-dimensional tabular format, but the display format is not limited thereto and may be a three-dimensional display.

For example, it may be configured such that one of a plurality of types of features selected by the user is assigned to the X-axis, another type is assigned to the Y-axis, and yet another type is assigned to the Z-axis, respectively, and the sample selected by the user is arranged in accordance with the features in the X-axis direction, the Y-axis direction, and the Z-axis direction, respectively, in the three-dimensional space formed by the X-axis, the Y-axis, and the Z-axis.

By configuring as described above, one point can be plotted for each sample in a three-dimensional space, and therefore, it becomes possible to quickly and easily grasp the relation between the types of features and the features among a plurality of samples visually.

### Description of Symbols

1: Training data generation system
3a ... 3n:Analysis device
4a ... 4n:Physical property data acquisition device
8: Data bus
10: Data processing device
11: Database
13: Feature extraction unit
15: Control unit
17: Operation Unit
19: Display unit
21: Memory
25: Display data generation unit
27: Training data generation unit
29: Learning processing unit

1. A method of generating, a trained model, comprising:
a step of constructing a database in which, for each of one or a plurality of types of samples, a sample identification tag and data belonging to at least two types of categories out of the following categories (1), (2), and (3) are stored in association with each other,
Category (1): a plurality of types of data relating to a production method of the sample,
Category (2): a plurality of types of analysis data acquired by analyzing the sample with one or a plurality of types of analyzers, and
Category (3): a plurality of types of physical property data that is information representing characteristics of the sample;
a selection step of selecting data to be used as training data in supervised learning from the database, the selection step including a step of selecting one or a plurality of types of data as an explanatory variable from one of the categories and a step of selecting one or a plurality types of data as an objective variable from the other category;
a step of generating training data in which data corresponding to the selected explanatory variable is served as input and data corresponding to the selected objective variable is served as ground truth output;, and
a step of generating the trained model corresponding to the generated training data by performing predetermined machine learning or statistical analysis based on the generated training data.

2. The method of generating trained model as recited in claim 1,
wherein the category (2) includes one or a plurality of types of feature data extracted from the analysis data.

3. (canceled)

4. The method of generating a trained model as recited in claim 1, further comprising:
a step of outputting the training data in a CSV (Comma-Separated Values) format.

5. The method of generating a trained model as recited in claim 2,
wherein the analyzers include at least two types of analyzers selected from a group consisting of a gas chromatograph mass spectrometer, a liquid chromatograph mass spectrometer, a Fourier transform infrared spectrophotometer, and a tensile testing machine, and
wherein the feature data includes at least two types of data selected from a group consisting of a peak area of a chromatogram, a peak area of a spectrum, a Young’s modulus, tensile strength, a deformation amount, a strain amount, and a fracture time.

6. The method of generating a trainedmodel as recited in claim 3,
wherein an algorithm of the machine learning is a support vector machine (SVM).

7. A data processing device configured to generate a training model comprising:
an input unit;
a storage unit configured to store a database in which, for each of one or a plurality of types of samples, a sample identification tag inputted by the input unit and data belonging to at least two types of categories out of following categories (1), (2), and (3) are stored in association with each other,
Category (1): a plurality of types of data relating to a production method of the sample,
Category (2): a plurality of types of analysis data acquired by analyzing the sample with one or a plurality of types of analyzers, and
Category (3): a plurality of types of physical property data that is information representing characteristics of the sample;
an operation unit configured to accept a selection of data to be used as training data in supervised learning from the database, the operation unit being configured to accept an operation to select one or a plurality of types of data as an explanatory variable from one of the categories and an operation to select one or a plurality of data as an objective variable from the other category;
a training data generation unit configured to generate training data in which data corresponding to the selected explanatory variable is served as input and data corresponding to the selected objective variable is served as ground truth output; and
a learning processing unit configured to generate a trained model corresponding to the generate training data by performing predetermined machine learning or statistical analysis based on the generated training data.
